(19) United States
(12) Patent Application Publication
(10) Pub. No.: US 2026/0307548 A1
(43) Pub. Date: Oct. 8, 2026

(54) SEAT POSITION IDENTIFYING DEVICE

(71) Applicant: TOYOTA JIDOSHA KABUSHIKI KAISHA, Toyota-shi (JP)

(72) Inventors: Kozo MATSUMOTO, Nisshin-shi (JP); Hisashi HAGIWARA, Toyota-shi (JP); Yu OBARA, Aichi-ken (JP)

(73) Assignee: TOYOTA JIDOSHA KABUSHIKI KAISHA, Toyota-shi (JP)

(21) Appl. No.: 19/549,570

(22) Filed: Feb. 25, 2026

(30) Foreign Application Priority Data
Apr. 3, 2025 (JP) 2025-061806

(51) Int. Cl. B60N 2/02; B60N 2/06

(52) U.S. Cl. CPC B60N 2/0272; B60N 2/06

(57) ABSTRACT

The seat position identifying device includes a first sensor unit and a second sensor unit disposed on sensor-disposed rails of the right seat rail and the left seat rail, a shielding plate and a shielding plate disposed on the sensor-disposed rails and suppressing detection of each sensor in a part of a sliding range of the sensor-disposed rails, and a seat position determining unit for identifying a sliding position based on a detection state of the plurality of sensors. The seat position determining unit identifies the sliding position in accordance with a combination of a first state in which the detection of each sensor is not obstructed by the shielding plate and a second state in which the detection of each sensor is obstructed by the shielding plate.

### CROSS-REFERENCE TO RELATED APPLICATION

This application claims priority to Japanese Patent Application No. 2025-061806 filed on Apr. 3, 2025. The disclosure of the above-identified application, including the specification, drawings, and claims, is incorporated by reference herein in its entirety.

### BACKGROUND

### 1. Technical Field

The present disclosure relates to a seat position identifying device.

### 2. Description of Related Art

Conventionally, a technology is known in which a detection state of one sensor is changed by a shielding plate provided with an inclined shape, and a sliding position on a seat rail of a vehicle is linearly identified based on a detection result of one sensor (e.g., Japanese Unexamined Patent Application Publication No. 2015-21887 (JP 2015-21887 A)).

### SUMMARY

In the technology of identifying the sliding position on the seat rail of the vehicle, in order to realize identifying of the sliding position with high accuracy in accordance with the shape of the shielding plate, as in the conventional technology, there is a problem in that new development of a sensor and a determining unit (circuit or logic) is required, and so forth, for example. Accordingly, there remains room for improvement regarding ease of realization of a configuration for identifying a sliding position on a seat rail of a vehicle in multiple stages.

One aspect of the present disclosure is

a seat position identifying device for identifying a sliding position on a seat rail of a vehicle, in which

the seat rail includes a right and left pair of a first rail and a second rail in the vehicle, the seat position identifying device including

a plurality of sensors disposed on a sensor-disposed rail that is at least one of the first rail and the second rail,

a member disposed on the sensor-disposed rail to obstruct detection by the sensor in a portion of a sliding range of the sensor-disposed rail, and

a seat position determining unit for identifying the sliding position based on detection states of the sensors, and

the seat position determining unit identifies the sliding position in accordance with a combination of a first state in which detection by the sensor is not obstructed by the member and a second state in which detection by the sensor is obstructed by the member.

In the seat position identifying device according to one aspect of the present disclosure, multiple sensors and the member that obstructs detection by each sensor in a part of the sliding range on the sensor-disposed rail are disposed on the sensor-disposed rail. In each of the sensors, there are the first state in which detection of the sensor is not obstructed by the member and the second state in which detection of the sensor is obstructed by the member. Thus, by combining the first state and the second state, the seat position determining unit can identify three or more sliding positions. Accordingly, it is possible to identify the sliding position on the seat rail of the vehicle in multiple stages with a simple configuration.

In one embodiment,

the sensor-disposed rail is both the first rail and the second rail,

the sensors are provided one each on the first rail and the second rail,

the member is provided one each on the first rail and the second rail, and

the seat position determining unit may identify the sliding position in accordance with three of the detection states, of when the sensors of the first rail and the second rail are both in the first state, when just the sensor of the first rail is in the second state, and when the sensors of the first rail and the second rail are both in the second state.

In one embodiment,

the sensor-disposed rail is both the first rail and the second rail,

the sensors are provided one each on the first rail and the second rail,

two of the members are provided on the first rail, and one is provided on the second rail, respectively, and

the seat position determining unit may identify the sliding position in accordance with four of the detection states, of when the sensors of the first rail and the second rail are both in the first state, when just the sensor of the first rail is in the second state, when just the sensor of the second rail is in the second state, and when the sensors of the first rail and the second rail are both in the second state.

In one embodiment,

the sensor-disposed rail is just the first rail,

two of the sensors are provided on the first rail,

one of the members is provided on the first rail, and

the seat position determining unit may identify the sliding position in accordance with three of the detection states, of when both of one of the sensors and another of the sensors are in the first state, when just the other of the sensors is in the second state, and when both of the one of the sensors and the other of the sensors are in the second state.

According to some aspects of the present disclosure, a sliding position on a seat rail of a vehicle can be identified in multiple stages with a simple configuration.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a seat position identifying device according to a first embodiment;

FIG. 2A is a diagram illustrating an example of a first condition in which detecting of a sensor is not obstructed by a member;

FIG. 2B is a schematic diagram of a second condition in which detecting of a sensor is obstructed by a member;

FIG. 3 is a diagram illustrating an example of sensor outputs in a first state and a second state;

Part (a) of FIG. 4 is a diagram illustrating an example in which the sensors of the first rail and the second rail are both in the first state, part (b) of FIG. 4 is a diagram illustrating an example in which only the sensors of the first rail are in the second state, and part (c) of FIG. 4 is a diagram illustrating an example in which the sensors of the first rail and the second rail are both in the second state;

FIG. 5 is a flowchart illustrating an example of the operation of the seat position identifying device of FIG. 1;

FIG. 6 is a block diagram illustrating a seat position identifying device according to a second embodiment;

Part (a) of FIG. 7 is a diagram illustrating an example of a case in which the sensors of the first rail and the second rail are both in the first state, part (b) of FIG. 7 is a diagram illustrating an example of a case in which only the sensor of the second rail is in the second state, part (c) of FIG. 7 is a diagram illustrating an example of a case in which only the sensor of the first rail is in the second state, and part (d) of FIG. 7 is a diagram illustrating an example of a case in which both the sensors of the first rail and the second rail are in the second state;

FIG. 8 is a flowchart illustrating an example of the operation of the seat position identifying device of FIG. 6;

FIG. 9 is a block diagram illustrating a seat position identifying device according to a third embodiment;

Part (a) of FIG. 10 is a diagram illustrating an example of a case where both one sensor and the other sensor are in the first state, part (b) of FIG. 10 is a diagram illustrating an example of a case where only the other sensor is in the second state, and part (c) of FIG. 10 is a diagram illustrating an example of a case where both the one sensor and the other sensor are in the second state; and

FIG. 11 is a flowchart illustrating an example of an operation of the seat position identifying device of FIG. 6.

### DETAILED DESCRIPTION OF EMBODIMENTS

Hereinafter, embodiments of the present disclosure will be described with reference to the drawings.

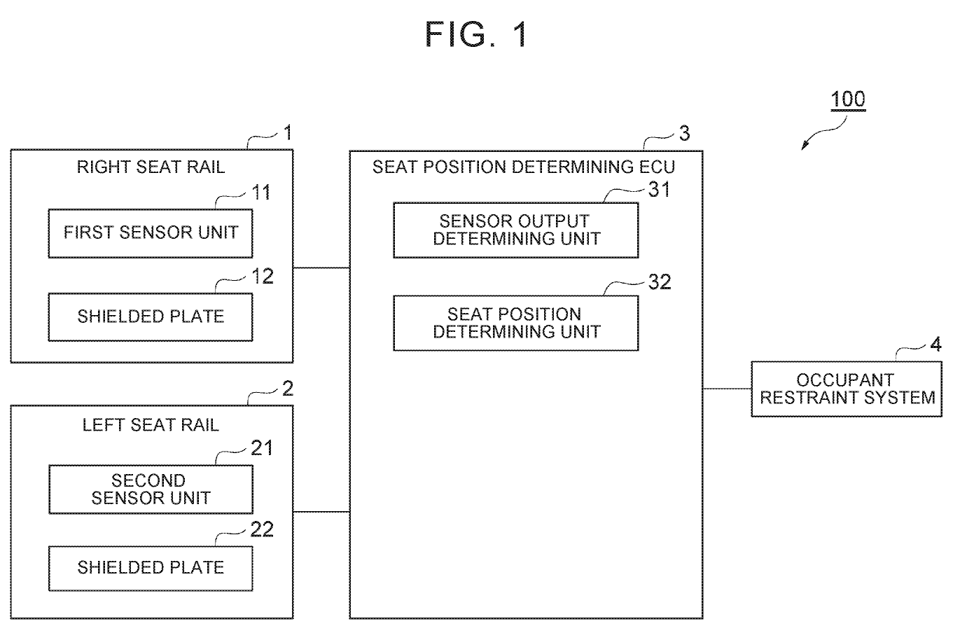

FIG. 1 is a block diagram illustrating a seat position identifying device according to a first embodiment. The seat position identifying device 100 is mounted on a vehicle such as a passenger car. The vehicle is not limited to a passenger car.

The vehicle includes a pair of left and right seat rails disposed in a vehicle width direction so as to support a seat on which an occupant sits. In the example of FIG. 1, the pair of left and right seat rails corresponds to the right seat rail 1 (first rail) and the left seat rail 2 (second rail). The seat rail slidably supports the seat within a predetermined sliding range along the vehicle front-rear direction. The seat rail may be driven by an electric motor or the like to continuously slide the seat, or may be unlocked by manual lever operation to slide the seat in a plurality of stages.

The right seat rail 1 includes a movable portion 1a and a fixed portion 1b (see parts (a) to (c) of FIG. 4). The fixed portion 1b is a rail member fixed to the vehicle body of the vehicle along the vehicle front-rear direction. The movable portion 1a is a rail member slidably provided with respect to the fixed portion 1b. The movable portion 1a is fixed to the bottom surface of the seat. The movable portion 1a slides with respect to the fixed portion 1b to slidably support the seat along the front-rear direction of the vehicle. A configuration related to the sliding function of the movable portion 1a and the fixed portion 1b may be a known configuration.

The left seat rail 2 includes a movable portion 2a and a fixed portion 2b (see parts (a) to (c) of FIG. 4). The fixed portion 2b is a rail member fixed to the vehicle body of the vehicle along the vehicle front-rear direction. The movable portion 2a is a rail member slidably provided with respect to the fixed portion 2b. The movable portion 2a is fixed to the bottom surface of the seat. The movable portion 2a slides with respect to the fixed portion 2b to slidably support the seat along the front-rear direction of the vehicle. A configuration related to the sliding function of the movable portion 2a and the fixed portion 2b may be a known configuration.

The seat position identifying device 100 is a device for identifying a sliding position of a seat rail of a vehicle. The sliding position of the seat rail means the position of the seat moved along the vehicle front-rear direction within the sliding range.

As illustrated in FIG. 1, the seat position identifying device 100 includes a first sensor unit 11 (sensor), a shielding plate 12 (member), and a second sensor unit 21 (sensor). The seat position identifying device 100 further includes a shielding plate 22 (member), a seat position determining ECU [Electronic Control Unit] 3, and an occupant restraint device 4.

The first sensor unit 11 and the shielding plate 12 are provided on the right seat rail 1. The second sensor unit 21 and the shielding plate 22 are provided on the left seat rail 2. That is, in the example of FIG. 1, both the right seat rail 1 and the left seat rail 2 are sensor-disposed rails. One each of the plurality of first sensor units 11 and the plurality of second sensor units 21 is provided in each of the right seat rail 1 and the left seat rail 2.

The first sensor unit 11 is disposed on one of the movable portion 1a and the fixed portion 1b in the right seat rail 1. The shielding plate 12 is disposed on the other of the movable portion 1a and the fixed portion 1b in the right seat rail 1. In parts (a) to (c) of FIG. 4, the first sensor unit 11 is disposed on the movable portion 1a of the right seat rail 1. The shielding plate 12 is disposed on the fixed portion 1b of the right seat rail 1.

The second sensor unit 21 is disposed on one of the movable portion 2a and the fixed portion 2b in the left seat rail 2. The shielding plate 22 is disposed on the other of the movable portion 2a and the fixed portion 2b in the left seat rail 2. In parts (a) to (c) of FIG. 4, the second sensor unit 21 is disposed on the movable portion 2a of the left-seat rail 2. The shielding plate 22 is disposed on the fixed portion 2b of the left seat rail 2.

In parts (a) to (c) of FIG. 4, the shielding plate 12 is disposed on the fixed portion 1b of the right seat rail 1. A shielding plate 22 is disposed on a fixed portion 2b of the left seat rail 2. In the extending direction of the right seat rail 1 and the left seat rail 2, the extending length of the shielding plate 12 is longer than that of the shielding plate 22. The rear end of the shielding plate 22 coincides with the rear end of the shielding plate 12. The front end of the shielding plate 12 is positioned forward of the front end of the shielding plate 22. The extension length of the shielding plate 22 may be longer than the length from the front end to the rear end of the second sensor unit 21.

As illustrated in 2A and 2B, the first sensor unit 11 and the second sensor unit 21 each include a magnetic 11a, 21a, a magnetic sensor 11b, 21b, and a support 11c, 21c.

In the first sensor unit 11, the magnetic 11a and the magnetic sensor 11b are supported on the support 11c so as to face each other via a space. The support 11c may be formed, for example, in a U-shaped cross section when viewed from the extension of the movable portion 1a and the fixed portion 1b of the right seat rail 1.

The shielding plate 12 is an exemplary member that suppresses the magnetic sensor 11b from being detected in a part of the sliding range of the movable portion 1a. The shielding plate 12 may be a plate-like member made of a magnetic material (for example, an iron-based material). The shielding plate 12 is attached to the fixed portion 1b of the right seat rail 1 so as to enter or exit a space (magnetic flux path) between the magnetic 11a of the first sensor unit 11 and the magnetic sensor 11b as the movable portion 1a and the fixed portion 1b move relatively when the seat is slid. A portion of the sliding range can be pre-set so as to suppress the magnetic sensor 11b from being detected and thereby distinguish the presence area (e.g., front, center, rear) of the sliding position of some seat rails.

The first sensor unit 11 and the second sensor unit 21 have the same configuration, for example. The shielding plate 12 and the shielding plate 22 have the same configuration, for example. One each of the shielding plate 12 and the shielding plate 22 is provided on each of the right seat rail 1 and the left seat rail 2.

The first sensor unit 11 and the second sensor unit 21 are not limited to the shape or the support structure of the support 11c as long as the detection result corresponding to the first state and the detection result corresponding to the second state can be outputted. The first sensor unit 11 and the second sensor unit 21 may have different configurations. The shielding plate 12 and the shielding plate 22 are not limited in shape or size as long as they can output the sensor output corresponding to the first state and the sensor output corresponding to the second state. The shielding plate 12 and the shielding plate 22 may have different configurations.

The seat position determining ECU 3 is an electronic control unit (computer) having CPU [Central Processing Unit], ROM [Read Only Memory], RAM [Random Access Memory], CAN [Controller Area Network] communication circuitry, and the like. In the seat position determining ECU 3, for example, various functions are realized by loading a program stored in a ROM into a RAM and executing the program loaded in RAM by a CPU. The seat position determining ECU 3 may include a plurality of electronic units. The seat position determining ECU 3 includes a ROM and a RAM as storage units. The seat position determining ECU 3 may include a EEPROM [Electrically Erasable Programmable Read-Only Memory] as a storage unit.

The occupant restraint device 4 is, for example, a device such as an airbag and a seatbelt pretensioner that operate in the event of a collision of a vehicle or the like. As the occupant restraint device 4, a configuration in which the operation can be adjusted according to the sliding position of the seat rail can be used. The occupant restraint device 4 may receive the sliding position of the seat rail from the seat position determining ECU 3 and operate in accordance with the sliding position of the seat rail. Note that the seat position identifying device 100 may not include the occupant restraint device 4.

The seat position determining ECU 3 is configured to receive a sensor output from the first sensor unit 11 and a signal related to a detection result of the second sensor unit 21. The seat position determining ECU 3 transmits a control signal including information about the sliding position of the seat rail to the occupant restraint device 4.

The seat position determining ECU 3 includes, as a functional configuration, a sensor output determining unit 31 and a seat position determining unit 32.

The sensor output determining unit 31 determines the sensor output based on the detection results from the first sensor unit 11 and the second sensor unit 21. The sensor output determining unit 31 determines the sensor output according to the positions of the shielding plates 12 and 22 with respect to the first sensor unit 11 and the second sensor unit 21 in association with the sliding of the movable portion 1a, 2a back and forth.

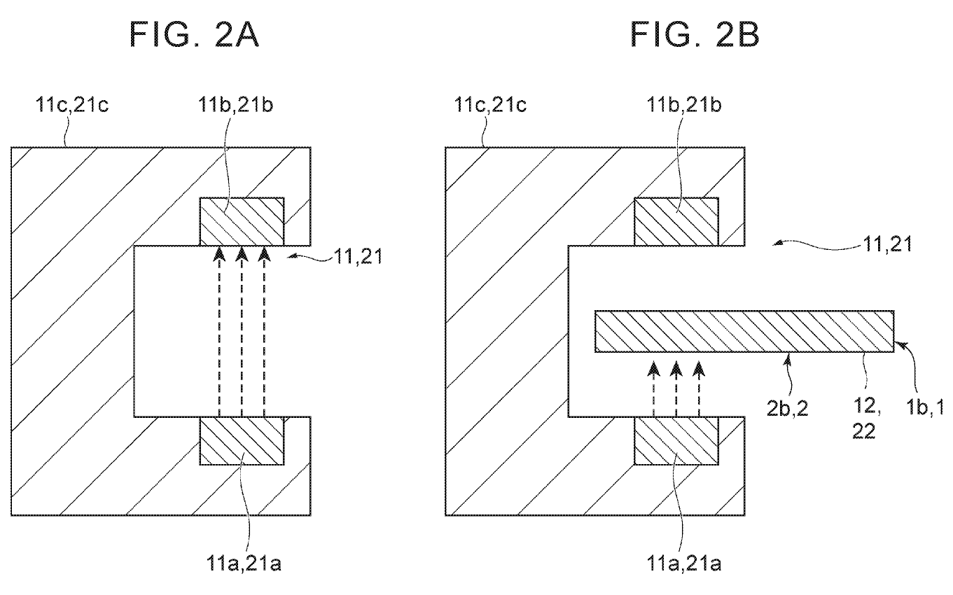

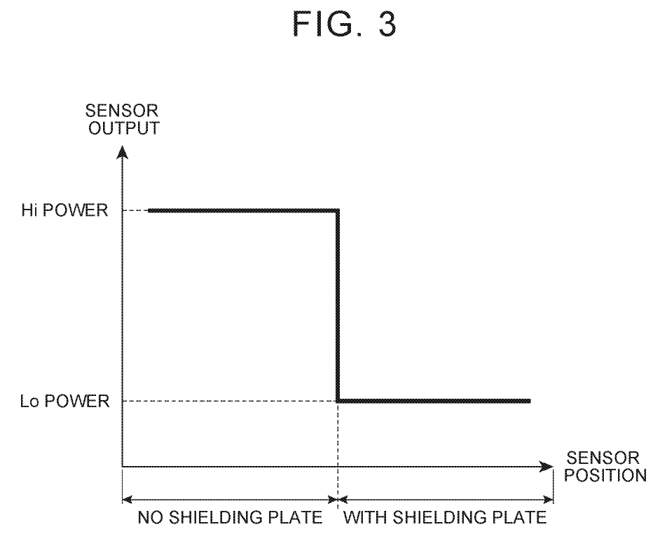

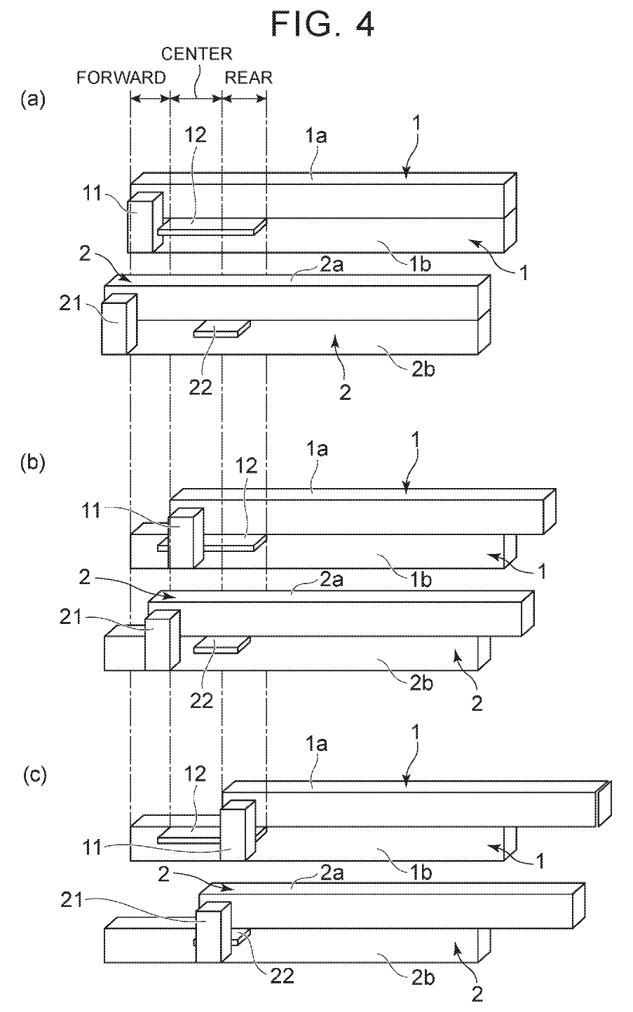

There is a case where the shielding plate 12 does not enter the space between the magnetic 11a and the magnetic sensor 11b (see FIG. 2A). Then, the sensor output determining unit 31 determines Hi output as the first output by the magnetic sensor 11b detecting the magnetic flux of the magnetic field caused by the magnetic 11a that is not blocked by the shielding plate 12 (see FIG. 3). The state in which Hi power is being output corresponds to a first state in which the sensor is not detected by the member. The first output is a sensor output of the first sensor unit 11.

In some cases, the shielding plate 12 enters a space between the magnetic 11a and the magnetic sensor 11b (see FIG. 2B). Then, the sensor output determining unit 31 determines Lo output as the first output by the magnetic sensor 11b detecting the magnetic flux of the magnetic field caused by the magnetic 11a shielded by the shielding plate 12 (see FIG. 3). The state in which Lo power is being output corresponds to a second state in which detecting of the sensor is blocked by the member.

Similarly to the first sensor unit 11, the second sensor unit 21, there is a case where the shielding plate 22 is not entering the space between the magnetic 21a and the magnetic sensor 21b (see FIG. 2A). Then, the sensor output determining unit 31 determines Hi output as the second output (see FIG. 3). When the shielding plate 22 is entering the space between the magnetic 21a and the magnetic sensor 21b (see FIG. 2B), the sensor output determining unit 31 determines Lo output as the second output (see FIG. 3). The second output is a sensor output of the second sensor unit 21.

The seat position determining unit 32 identifies the sliding position of the seat rail based on the detection results from the first sensor unit 11 and the second sensor unit 21. The seat position determining unit 32 identifies the sliding position of the seat rail in accordance with a combination of a first state in which the detection of the sensor is not obstructed by the member and a second state in which the detection of the sensor is obstructed by the member. For example, the seat position determining unit 32 identifies the sliding position of the seat rail according to the combination of the first output and the second output (the combination of Hi output and Lo output).

In the seat position identifying device 100, the seat position determining unit 32 identifies the sliding position according to the three detection states when the sensors of the right seat rail 1 and the left seat rail 2 are both in the first state, when only the sensor of the right seat rail 1 is in the second state, and when the sensors of the right seat rail 1 and the left seat rail 2 are both in the second state.

For example, as illustrated in part (a) of FIG. 4, when both the first output and the second output are Hi outputs, the seat position determining unit 32 identifies that the seat is positioned forward. For example, as illustrated in part (b) of FIG. 4, when the first output is Lo output and the second output is Hi output, the seat position determining unit 32 identifies that the seat is located at the center. For example, as illustrated in part (c) of FIG. 4, when both the first output and the second output are Lo outputs, the seat position determining unit 32 identifies that the seat is positioned rearward. In the present embodiment, the seat position determining unit 32 can identify the sliding position of the seat rail in three stages according to the combination of the three sensor outputs.

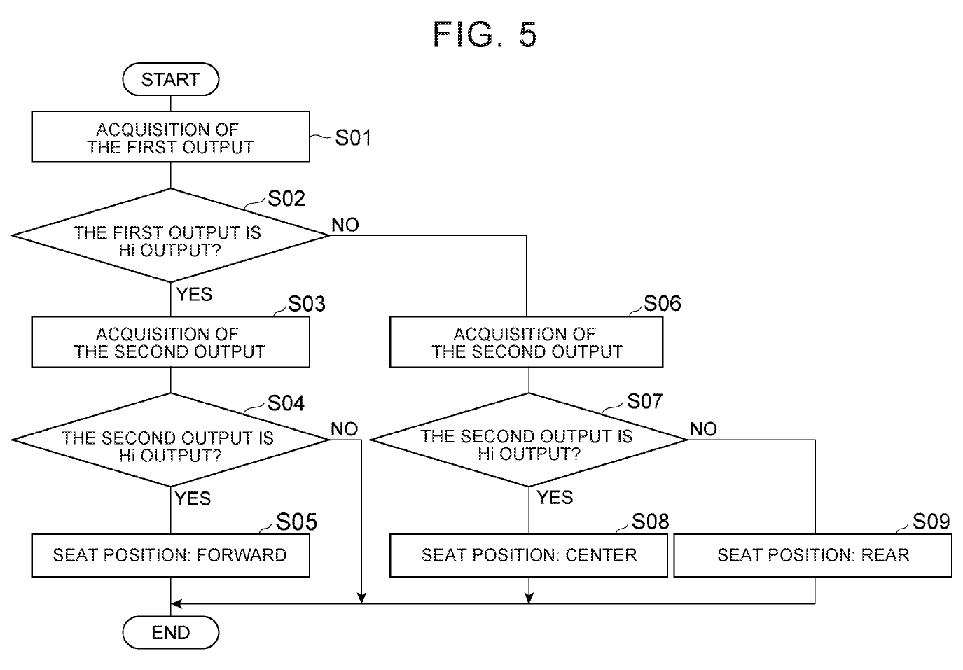

Next, the operation of the seat position identifying device 100 will be described with reference to FIG. 5. The process of the flowchart of FIG. 5 may be executed at predetermined calculation cycles, for example, when the seat position determining ECU 3 is powered on.

First, in S01, the seat position determining ECU 3 acquires the first output by the sensor output determining unit 31. The sensor output determining unit 31 determines the first output based on the detection result of the first sensor unit 11. Next, in S02, the seat position determining ECU 3 determines whether or not the first output is a Hi output by the seat position determining unit 32. When the first output is Hi output (S02: YES), the seat position determining ECU 3 acquires the second output by the sensor output determining unit 31 in S03. The sensor output determining unit 31 determines the second output based on the detection result of the second sensor unit 21.

In S04, the seat position determining ECU 3 determines whether or not the second output is a Hi output by the seat position determining unit 32. When the second output is Hi output (S04: YES), the seat position determining ECU 3 identifies the sliding position of the seat rail as "front" by the seat position determining unit 32 in S05. The seat position determining unit 32 corresponds to the combination of the sensor outputs that both sensors are in the first state as in the example of part (a) of FIG. 4, and identifies the sliding position of the seat rail as "front". Thereafter, the seat position determining ECU 3 ends the process of FIG. 5.

On the other hand, when the first output is not Hi output in S02 (S02: NO), in S06, the seat position determining ECU 3 acquires the second output by the sensor output determining unit 31. The sensor output determining unit 31 determines the second output based on the detection result of the second sensor unit 21.

In S07, the seat position determining ECU 3 determines whether or not the second output is a Hi output by the seat position determining unit 32. When the second output is Hi output (S07: YES), the seat position determining ECU 3 identifies the sliding position of the seat rail as the "center" by the seat position determining unit 32 in S08. As in the example of part (b) of FIG. 4, the seat position determining unit 32 corresponds to the combination of the sensor outputs that the first sensor unit 11 is in the second state and the second sensor unit 21 is in the first state, and identifies the sliding position of the seat rail as the "center". Thereafter, the seat position determining ECU 3 ends the process of FIG. 5.

When the second output is not Hi output in S07 (S07: NO), the seat position determining ECU 3 identifies the sliding position of the seat rail as "rear" by the seat position determining unit 32 in S09. The seat position determining unit 32 corresponds to the combination of the sensor outputs that both sensors are in the second state as in the example of part (c) of FIG. 4, and identifies the sliding position of the seat rail as "rear". Thereafter, the seat position determining ECU 3 ends the process of FIG. 5.

As described above, in the seat position identifying device 100, two sensors (the first sensor unit 11 and the second sensor unit 21) are disposed on the sensor-disposed rails (the right seat rail 1 and the left seat rail 2). The sensor-disposed rails (the right seat rail 1 and the left seat rail 2) are further provided with two members (the shielding plate 12 and the shielding plate 22) that suppress detection of the sensors in a part of the sliding range of the sensor-disposed rails. In each of the two sensors, there is a first state in which detection of the sensor is not obstructed by the member and a second state in which detection of the sensor is obstructed by the member. Thus, by combining the first state and the second state, the seat position determining unit 32 can identify three sliding positions in this example. Therefore, the sliding positions of the right seat rail 1 and the left seat rail 2 of the vehicle can be identified in multiple stages with a simple configuration.

In the seat position identifying device 100, the sensor-disposed rails are both the right seat rail 1 and the left seat rail 2. The two sensors are a first sensor unit 11 and a second sensor unit 21 provided one on each of the right seat rail 1 and the left seat rail 2. The members are a shielding plate 12 and a shielding plate 22 provided one each on the right seat rail 1 and the left seat rail 2. The seat position determining unit 32 identifies the sliding position according to the three detected states when the sensors of the right seat rail 1 and the left seat rail 2 are both Hi output (first state), when only the sensor of the right seat rail 1 is Lo output (second state), and when the sensors of the right seat rail 1 and the left seat rail 2 are both Lo output. In this way, the sliding position of the seat rail of the vehicle can be identified in three stages with a simple configuration in which Hi output or Lo output of the two sensors are combined.

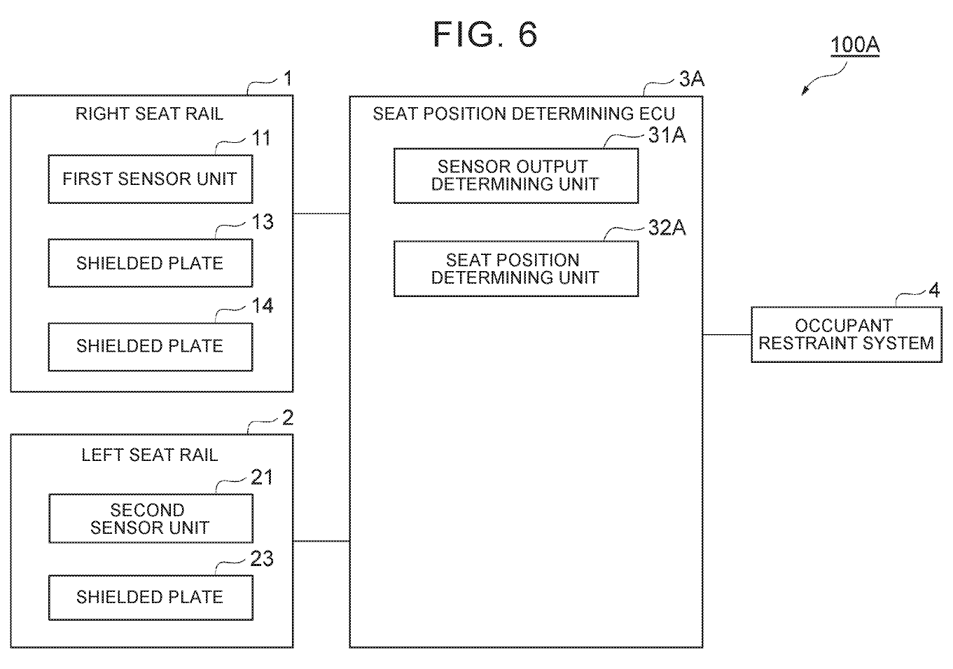

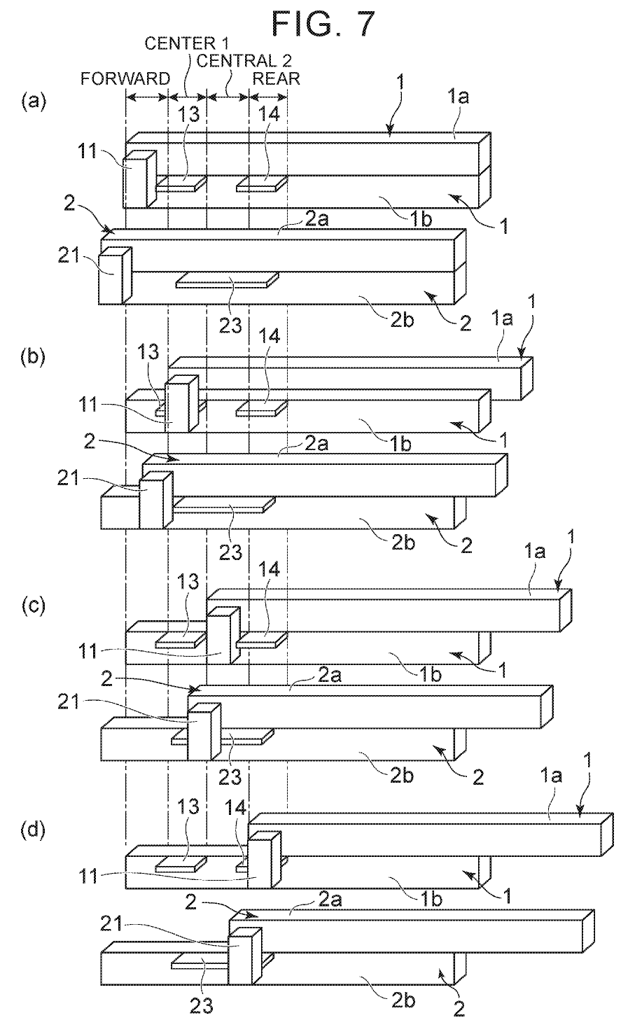

Next, a second embodiment will be described with reference to FIGS. 6 to 8. The second embodiment is the same as the first embodiment in that the sensor-disposed rail is both the first rail and the second rail. However, it is different from the first embodiment in that two shielding plates 13 and 14 (members) are provided on the fixed portion 1b of the right seat rail 1, and one shielding plate 23 (member) is provided on the fixed portion 2b of the left seat rail 2.

As illustrated in FIG. 6, the seat position identifying device 100A according to the second embodiment includes a seat position determining ECU 3A including a sensor output determining unit 31A and a seat position determining unit 32A in place of the seat position determining ECU 3. The seat position determining ECU 3A is different from the seat position determining ECU 3 in that the content of the determination is changed in accordance with the difference in the disposing and configuration of the sensor and the member.

As shown in FIG. 6 and parts (a) to (d) of FIG. 7, the first sensor unit 11 is attached to the movable portion 1a of the right seat rail 1. The second sensor unit 21 is attached to the movable portion 2a of the left seat rail 2. Both sensors are similar to the first embodiment in that Hi output or Lo output is generated by a combination of magnets and magnetic sensors.

In parts (a) to (d) of FIG. 7, the shielding plate 13 and the shielding plate 14 are spaced apart from each other on the fixed portion 1b of the right seat rail 1. The shielding plate 14 is disposed rearward of the shielding plate 13. A shielding plate 23 is disposed on the fixed portion 2b of the left seat rail 2. In the extending direction of the right seat rail 1 and the left seat rail 2, the extending length of the shielding plate 23 is longer than that of the shielding plate 14. The rear end of the shielding plate 23 coincides with the rear end of the shielding plate 14. The front end of the shielding plate 23 is positioned forward of the front end of the shielding plate 14 and coincides with the rear end of the shielding plate 13. The extension length of the shielding plate 13 is the same as that of the shielding plate 14. The extension length of the shielding plate 13 may be longer than the length from the front end to the rear end of the first sensor unit 11. The extension length of the shielding plate 14 may be longer than the length from the front end to the rear end of the first sensor unit 11.

In the seat position identifying device 100A, the seat position determining unit 32A identifies the sliding positions according to the four detected states when the sensors of the right seat rail 1 and the left seat rail 2 are both in the first state, when only the sensor of the right seat rail 1 is in the second state, when only the sensor of the left seat rail 2 is in the second state, and when the sensors of the right seat rail 1 and the left seat rail 2 are both in the second state.

For example, as illustrated in part (a) of FIG. 7, when both the first output and the second output are Hi outputs, the seat position determining unit 32A identifies that the seat is positioned forward. For example, as illustrated in part (b) of FIG. 7, when the first output is Lo output and the second output is Hi output, the seat position determining unit 32A identifies that the seat is located at the center 1. The center 1 is a region closer to the front side of the center region between the front side and the rear side. For example, as illustrated in part (c) of FIG. 7, when the first output is Hi output and the second output is Lo output, the seat position determining unit 32A identifies that the seat is located at the center 2. The center 2 is a rearward region of the center region between the front and the rear. For example, as illustrated in part (d) of FIG. 7, when both the first output and the second output are Lo outputs, the seat position determining unit 32A identifies that the seat is positioned rearward. In the present embodiment, the seat position determining unit 32A can identify the sliding position of the seat rail in four stages according to the combination of the four sensor outputs.

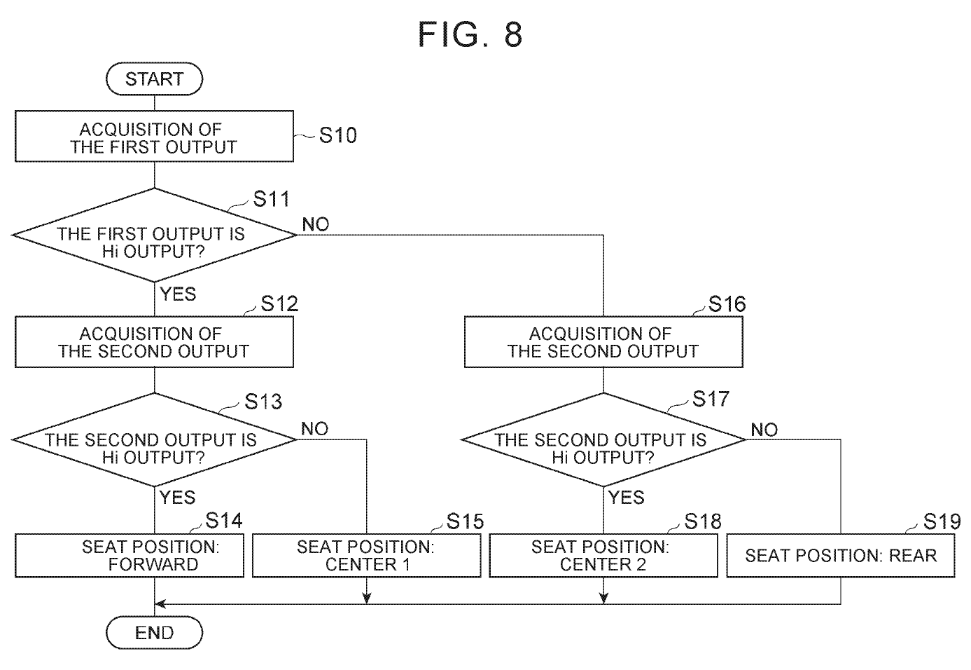

Next, referring to FIG. 8, the operation of the seat position identifying device 100A will be described. The process of the flowchart of FIG. 8 may be executed at predetermined calculation cycles, for example, when the seat position determining ECU 3A is powered on.

First, in S10, the seat position determining ECU 3A acquires the first output by the sensor output determining unit 31A. The sensor output determining unit 31A determines the first output based on the detection result of the first sensor unit 11. Next, in S11, the seat position determining ECU 3A determines whether or not the first output is a Hi output by the seat position determining unit 32A. When the first output is Hi output (S11: YES), the seat position determining ECU 3A acquires the second output by the sensor output determining unit 31A in S12. The sensor output determining unit 31A determines the second output based on the detection result of the second sensor unit 21.

In S13, the seat position determining ECU 3A determines whether or not the second output is a Hi output by the seat position determining unit 32A. When the second output is Hi output (S13: YES), the seat position determining ECU 3A identifies, in S14, the sliding position of the seat rail as "front" by the seat position determining unit 32A. The seat position determining unit 32A corresponds to a combination of sensor outputs that both sensors are in the first state as illustrated in part (a) of FIG. 7, and identifies the sliding position of the seat rail as "front". Thereafter, the seat position determining ECU 3A ends the process of FIG. 8.

On the other hand, when the second output is not Hi output in S13 (S13: NO), the seat position determining ECU 3A identifies the sliding position of the seat rail as "center 1" by the seat position determining unit 32A in S15. The seat position determining unit 32A corresponds to a combination of sensor outputs indicating that the first sensor unit 11 is in the second state and the second sensor unit 21 is in the first state as illustrated in part (b) of FIG. 7, and identifies the sliding position of the seat rail as "center 1". Thereafter, the seat position determining ECU 3A ends the process of FIG. 8.

On the other hand, when the first output is not Hi output in S11 (S11: NO), in S16, the seat position determining ECU 3A acquires the second output by the sensor output determining unit 31A. The sensor output determining unit 31A determines the second output based on the detection result of the second sensor unit 21.

In S17, the seat position determining ECU 3A determines whether or not the second output is a Hi output by the seat position determining unit 32A. When the second output is Hi output (S17: YES), the seat position determining ECU 3A identifies, in S18, the sliding position of the seat rail as "center 2" by the seat position determining unit 32A. The seat position determining unit 32A corresponds to a combination of sensor outputs indicating that the first sensor unit 11 is in the first state and the second sensor unit 21 is in the second state as illustrated in part (c) of FIG. 7, and identifies the sliding position of the seat rail as "center 2". Thereafter, the seat position determining ECU 3A ends the process of FIG. 8.

When the second output is not Hi output in S17 (S17: NO), the seat position determining ECU 3A identifies, in S19, the sliding position of the seat rail as "rear" by the seat position determining unit 32A. The seat position determining unit 32A corresponds to a combination of sensor outputs that both sensors are in the second state as illustrated in part (d) of FIG. 7, and identifies the sliding position of the seat rail as "rear". Thereafter, the seat position determining ECU 3A ends the process of FIG. 8.

As described above, in the seat position identifying device 100A, the sensor-disposed rail is both the right seat rail 1 and the left seat rail 2. The two sensors are a first sensor unit 11 and a second sensor unit 21 provided one on each of the right seat rail 1 and the left seat rail 2. The members are two shielding plates 13, 14 and a shielding plate 23 provided on the right seat rail 1 and one on the left seat rail 2. The seat position determining unit 32A identifies the sliding positions according to the four detected states when the sensors of the right seat rail 1 and the left seat rail 2 are both in the first state, when only the sensor of the right seat rail 1 is in the second state, when only the sensor of the left seat rail 2 is in the second state, and when the sensors of the right seat rail 1 and the left seat rail 2 are both in the second state. In this way, the sliding position of the seat rail of the vehicle can be identified in four stages with a simple configuration in which Hi output or Lo output of the two sensors are combined.

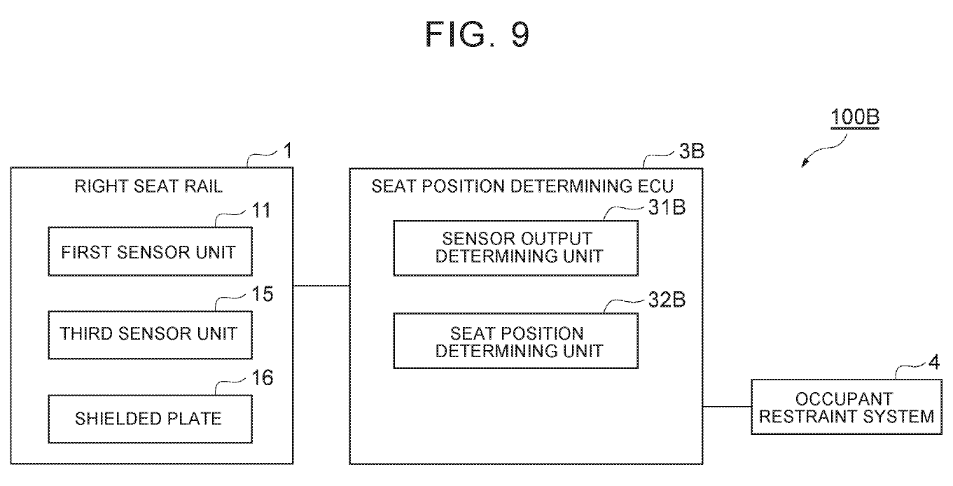

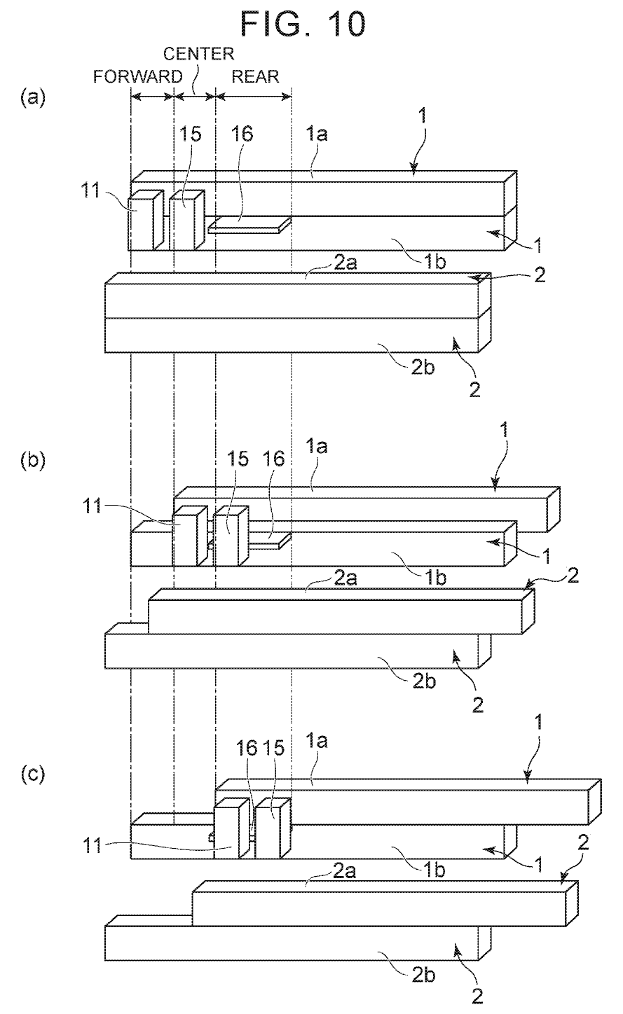

Next, a third embodiment will be described with reference to FIGS. 9 to 11. The third embodiment is different from the first embodiment and the second embodiment as follows: 1. the sensor-disposed rail is only the first rail, 2. one shielding plate 16 (member) is provided on the fixed portion 1b side of the right seat rail 1, and two sensors (the first sensor unit 11 and the third sensor unit 15) are provided on the movable portion 1a side of the right seat rail 1.

As illustrated in FIG. 9, the seat position identifying device 100B according to the third embodiment includes a seat position determining ECU 3B including a sensor output determining unit 31B and a seat position determining unit 32B in place of the seat position determining ECU 3. The seat position determining ECU 3B is different from the seat position determining ECU 3, 3A in that the content of the determination is changed in accordance with the difference in the disposing and configuration of the sensor and the member.

FIG. 9 and parts (a) to (c) of FIG. 10, the movable portion 1a of the right seat rail 1, the first sensor unit 11 and the third sensor unit 15 (sensor) is attached. The third sensor unit 15 is configured similarly to the first sensor unit 11. Both sensors are similar to the first and second embodiments in that Hi or Lo outputs are generated by combining magnets and magnetic sensors. The first sensor unit 11 is disposed in front of the third sensor unit 15 in the extending direction of the right seat rail 1. Since the left seat rail 2 does not have a sensor, it is not a sensor-disposed rail.

In parts (a) to (c) of FIG. 10, the shielding plate 16 is disposed on the fixed portion 1b of the right seat rail 1. The front end of the shielding plate 16 is positioned rearward of the rear end of the third sensor unit 15 in a state where the right seat rail 1 is slid to the front most. The shielding plate 16 is configured to suppress the detection of both the first sensor unit 11 and the third sensor unit 15 in a part of the sliding range of the movable portion 1a. In the extending direction of the right seat rail 1, the extending length of the shielding plate 16 may be longer than the length from the front end of the first sensor unit 11 to the rear end of the third sensor unit 15.

In the seat position identifying device 100B, the seat position determining unit 32B identifies the sliding position in accordance with the three detected states in a case where the one sensor and the other sensor of the first sensor unit 11 and the third sensor unit 15 are both in the first state, a case where only the other sensor is in the second state, and a case where both the one sensor and the other sensor are in the second state.

For example, as illustrated in part (a) of FIG. 10, when both the first output and the third output are Hi outputs, the seat position determining unit 32B identifies that the seat is positioned forward. The third output is a sensor output of the third sensor unit 15. For example, as illustrated in part (b) of FIG. 10, when the third output is Lo output and the first output is Hi output, the seat position determining unit 32B identifies that the seat is located at the center. For example, as illustrated in part (c) of FIG. 10, when both the first output and the third output are Lo outputs, the seat position determining unit 32B identifies that the seat is positioned rearward. In the present embodiment, the seat position determining unit 32B can identify the sliding position of the seat rail in three stages according to the combination of the three sensor outputs.

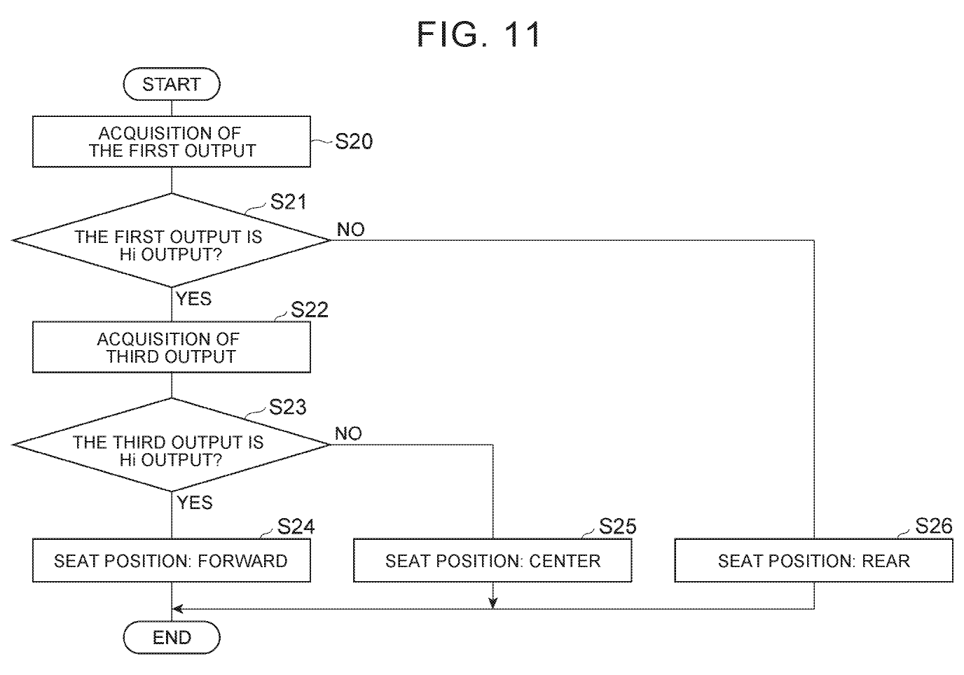

Next, referring to FIG. 11, the operation of the seat position identifying device 100B will be described. The process of the flowchart of FIG. 11 may be executed at predetermined calculation cycles, for example, when the seat position determining ECU 3B is powered on.

First, in S20, the seat position determining ECU 3B acquires the first output by the sensor output determining unit 31B. The sensor output determining unit 31B determines the first output based on the detection result of the first sensor unit 11. Next, in S21, the seat position determining ECU 3B determines whether or not the first output is a Hi output by the seat position determining unit 32B. When the first output is Hi output (S21: YES), the seat position determining ECU 3B acquires the third output by the sensor output determining unit 31B in S22. The sensor output determining unit 31B determines the third output based on the detection result of the third sensor unit 15.

In S23, the seat position determining ECU 3B determines whether or not the third output is a Hi output by the seat position determining unit 32B. When the third output is Hi output (S23: YES), the seat position determining ECU 3B identifies, in S24, the sliding position of the seat rail as "front" by the seat position determining unit 32B. The seat position determining unit 32B corresponds to a combination of sensor outputs that both sensors are in the first state as illustrated in part (a) of FIG. 10, and identifies the sliding position of the seat rail as "front". Thereafter, the seat position determining ECU 3B ends the process of FIG. 11.

On the other hand, when the third output is not Hi output in S23 (S23: NO), the seat position determining ECU 3B identifies the sliding position of the seat rail as the "center" by the seat position determining unit 32B in S25. The seat position determining unit 32B corresponds to a combination of sensor outputs indicating that the third sensor unit 15 is in the second state and the first sensor unit 11 is in the first state as illustrated in part (b) of FIG. 10, and identifies the sliding position of the seat rail as "center". Thereafter, the seat position determining ECU 3B ends the process of FIG. 11.

On the other hand, when the first output is not Hi output in S21 (S21: NO), in S26, the seat position determining ECU 3B identifies the sliding position of the seat rail as "rear" by the seat position determining unit 32B. The seat position determining unit 32B corresponds to a combination of sensor outputs that both sensors are in the second state as illustrated in part (c) of FIG. 10, and identifies the sliding position of the seat rail as "rear". Thereafter, the seat position determining ECU 3B ends the process of FIG. 11.

As described above, in the seat position identifying device 100B, the sensor-disposed rail is only the right seat rail 1. The two sensors are a first sensor unit 11 and a third sensor unit 15 provided in two on the right seat rail 1. The member is a shielding plate 16 provided on one right seat rail 1. The seat position determining unit 32B identifies the sliding position according to the three detected states when the first sensor unit 11 (one sensor) and the third sensor unit 15 (the other sensor) are both in the first state, when only the third sensor unit 15 is in the second state, and when both the first sensor unit 11 and the third sensor unit 15 are in the second state. In this way, the sliding position of the seat rail of the vehicle can be identified in three stages with a simple configuration in which Hi output or Lo output of the two sensors are combined.

Although the embodiments of the present disclosure have been described above, the present disclosure is not limited to the above-described embodiments. The present disclosure may be embodied in various forms with various changes and modifications, including the above-described embodiments, based on the knowledge of those skilled in the art.

In the above embodiments, the first sensor unit 11 is disposed on the movable portion 1a of the right seat rail 1, but may be disposed on the fixed portion 1b. In this case, the shielding plate 12 may be disposed on the movable portion 1a of the right seat rail 1. The same applies to other sensors and members.

In each of the above-described embodiments, a configuration in which the sliding positions of the seat rails of the vehicle are identified in three stages or four stages by using two sensors has been illustrated, but the present disclosure is not limited to these examples. For example, three or more sensors may be used to identify the sliding position in five or more stages.

In each of the above-described embodiments, the configuration in which the first state and the second state are determined by using the first sensor unit 11 or the like using a magnet as a sensor has been exemplified, but the physical quantity detected by the sensor is not limited to this example. For example, the first state and the second state may be determined by combining the optical sensor and the light shielding plate.

In the above embodiments, the sliding position of the seat rail of the vehicle identified by the seat position identifying device 100, 100A, 100B is used to adjust the operation of the occupant restraint device 4, but the present disclosure is not limited thereto. For example, the sliding position of the seat rail of the vehicle identified by the seat position identifying device may be used for applications other than the operation of the occupant restraint device 4, or the seat position identifying device may be used as a single device.

What is claimed is:

1. A seat position identifying device for identifying a sliding position on a seat rail of a vehicle, wherein
the seat rail includes a right and left pair of a first rail and a second rail in the vehicle, the seat position identifying device comprising:
a plurality of sensors disposed on a sensor-disposed rail that is at least one of the first rail and the second rail;
a member disposed on the sensor-disposed rail to obstruct detection by the sensor in a portion of a sliding range of the sensor-disposed rail; and
a seat position determining unit for identifying the sliding position based on detection states of the sensors, and
the seat position determining unit identifies the sliding position in accordance with a combination of a first state in which detection by the sensor is not obstructed by the member and a second state in which detection by the sensor is obstructed by the member.

2. The seat position identifying device according to claim 1, wherein
the sensor-disposed rail is both the first rail and the second rail,
the sensors are provided one each on the first rail and the second rail,
the member is provided one each on the first rail and the second rail, and
the seat position determining unit identifies the sliding position in accordance with three of the detection states, of when the sensors of the first rail and the second rail are both in the first state, when just the sensor of the first rail is in the second state, and when the sensors of the first rail and the second rail are both in the second state.

3. The seat position identifying device according to claim 1, wherein
the sensor-disposed rail is both the first rail and the second rail,
the sensors are provided one each on the first rail and the second rail,
two of the members are provided on the first rail, and one is provided on the second rail, respectively, and
the seat position determining unit identifies the sliding position in accordance with four of the detection states, of when the sensors of the first rail and the second rail are both in the first state, when just the sensor of the first rail is in the second state, when just the sensor of the second rail is in the second state, and when the sensors of the first rail and the second rail are both in the second state.

4. The seat position identifying device according to claim 1, wherein
the sensor-disposed rail is just the first rail,
two of the sensors are provided on the first rail,
one of the members is provided on the first rail, and
the seat position determining unit identifies the sliding position in accordance with three of the detection states, of when both of one of the sensors and another of the sensors are in the first state, when just the other of the sensors is in the second state, and when both of the one of the sensors and the other of the sensors are in the second state.
